(19) United States
(12) Patent Application Publication
(10) Pub. No.: US 2020/0271372 A1
(43) Pub. Date: Aug. 27, 2020

(54) DOOR HINGE DEVICE AND REFRIGERATOR HAVING DOOR HINGE DEVICE

(71) Applicant: QINGDAO HAIER CO., LTD., Qingdao City, Shandong Province (CN)

(72) Inventors: BIN FEI, Qingdao City, Shandong Province (CN); YIHAO XU, Qingdao City, Shandong Province (CN); DENGQIANG LI, Qingdao City, Shandong Province (CN); YAZHOU SHANG, Qingdao City, Shandong Province (CN)

(21) Appl. No.: 16/649,623

(22) PCT Filed: Nov. 15, 2018
(86) PCT No.: PCT/CN2018/115572

§ 371 Date: Mar. 20, 2020

(30) Foreign Application Priority Data
Dec. 30, 2017 (CN) 201711488574.8

(51) Int. Cl. F25D 23/02; E05F 3/20

(52) U.S. Cl. CPC F25D 23/028; E05Y 2900/31; F25D 2323/024; E05F 3/20

(57) ABSTRACT

A door hinge device comprises a hinge base and an auxiliary door-closing mechanism mounted on a door and fitted with the hinge base. The auxiliary door-closing mechanism comprises a shell, an elastic member for driving the door to be automatically closed during the door closing process, a sliding member, and a guiding member for guiding the sliding member to move in the deformation direction of the elastic member during the door opening and closing process. One end of the elastic member is connected to the shell, an accommodating part for accommodating the sliding member when the door is in a closed state and a guiding bevel obliquely extending forwards to approach the auxiliary door-closing mechanism are arranged on the periphery of the hinge base in a concave manner, and the sliding member is in a compressed state when moving along the guiding bevel.

The present application claims priority to Chinese Patent Application No. 201711488574.8, filed to the Chinese Patent Office on Dec. 30, 2017 and titled “Door Hinge Device and Refrigerator Having Door Hinge Device”, the content of which is incorporated herein by reference in its entirety.

### TECHNICAL FIELD

The present invention relates to the field of refrigeration devices, and particularly to a door hinge device which is structurally simple and capable of implementing automatic closing of the door, and a refrigerator having the door hinge device.

### BACKGROUND

At present, an auxiliary door-closing mechanism of a refrigerator generally comprises the following cases: 1. a magnetic stripe type: a magnetic stripe is mounted in a door gasket of the door so that when the user closes the door to a certain angle, the door is automatically closed by means of attraction of the magnetic stripe, but the magnetic stripe may reduce the temperature-preserving performance of the door gasket; 2. a plastic hook type hinge device: when the refrigerator door is manually closed from a maximum opening angle to a certain angle, the hook on a plastic member contacts a protrusion on an edge of a hinge base; when the door is further closed with a force, the plastic hook elastically deforms until it goes beyond a critical point of the protrusion, and the door automatically closes under action of an elastic restoring force of the plastic hook; however, the plastic hook has a small elasticity, and automatic closing of the door can only be implemented only when the door is closed manually to a very small angle; moreover, the plastic hook is prone to wear and damage due to collision; 3. a vertical spring-driven hinge device: when the refrigerator door is manually closed from a maximum opening angle to a certain angle, a center crosses a critical point of a cam, and the elastic restoring force of the vertical spring causes the center to counteract upon the cam so that the cam rotates and drives the door to close automatically; however, the vertical spring-driven hinge device is structurally complex and costly and only adapted for high-end refrigerators; furthermore, a vertical component of the vertical force provided by the vertical spring is offset so that the energy loses and the efficiency is low.

In view of the above cases, it is necessary to provide an improved door hinge device and a refrigerator having the same to solve the above problems.

### SUMMARY

An object of the present invention is to provide a door hinge device which is structurally simple and capable of implementing automatic closing of the door, and a refrigerator having the door hinge device.

In order to realize the purpose of the invention, the invention adopts the following technology program: A door hinge device, comprising a hinge base to which a door is rotatably connected, wherein the door hinge device further comprises an auxiliary door-closing mechanism, the auxiliary door-closing mechanism comprises a shell secured to the door, an elastic piece bringing the door to close automatically during closing of the door, a sliding piece disposed at one end of the elastic piece adjacent to the hinge base, and a guiding piece for guiding the sliding piece to move in a deformation direction of the elastic piece during opening and closing the door; an end of the elastic piece away from the hinge base is connected to the shell, a peripheral edge of the hinge base is concavely provided with an accommodating part for receiving the sliding piece when door is in a closed state, and with a guiding bevel extending obliquely forward from a front end of the accommodating part toward close to the auxiliary door-closing mechanism; the elastic piece is in a compressed state when the sliding piece moves along the guiding bevel.

Optionally, the auxiliary door-closing mechanism further comprises a linear compression damper, one end of the linear compression damper is connected to the sliding piece, the other end is connected to the shell, and an axial extension direction of the linear compression damper is the same as the deformation direction of the elastic piece.

Optionally, the linear compression damper comprises a casing and a piston rod at least partially inserted into the casing, and the piston rod can move in the axial direction of the linear compression damper to change a length of linear compression damper.

Optionally, the elastic piece is a spring, and the spring is sleeved around the linear compression damper.

Optionally, the sliding piece comprises a fixing base abutting against the elastic piece, a roller, and a rotating shaft that rotatably connects the roller to the fixing base; the roller rolls along the guiding bevel during opening and closing the door.

Optionally, the shell comprises a first wall fixed to the door, the guiding piece comprises a first bump disposed on a side of the sliding piece towards the first wall, and the first wall is provided with a first sliding groove mating with the first bump and extending in a deformation direction of the elastic piece.

Optionally, the shell further comprises a second wall disposed opposite to and spaced apart from the first wall, the guiding piece further comprises a second bump disposed on a side of the sliding piece towards the second wall, and the second wall is provided with a second sliding groove mating with the second bump and extending in the deformation direction of the elastic piece.

Optionally, the shell further comprises a connecting wall located at a side away from the hinge base and configured to connect the first wall with the second wall, and an end of the elastic piece away from the sliding piece abuts against the connecting wall.

In order to realize the purpose of the invention, the invention provides a refrigerator, wherein the refrigerator comprises a cabinet, a door, and the door hinge device according to any of claims 1-8; the hinge base is mounted on the cabinet, and the auxiliary door-closing mechanism is mounted on the door.

Optionally, the door is concavely provided with a receiving cavity for receiving the auxiliary door-closing mechanism.

Advantageous effects of the present invention are as follows: in the door hinge device according to the present invention, the peripheral edge of the hinge base is provided with the guiding bevel cooperating with the auxiliary door-closing mechanism, and sliding piece is driven by the elastic restoring force of the elastic piece to move along the guiding bevel towards the accommodating part, thereby providing assistance to the user upon closing the door, achieving automatic closing of the door, meanwhile simplifying the structure of the auxiliary door-closing mechanism and providing durability.

### BRIEF DESCRIPTION OF THE DRAWINGS

FIG. 1 is a structural schematic view of a door hinge device according to the present invention.

FIG. 2 is an exploded view of the door hinge device as shown in FIG. 1.

FIG. 3 is an exploded view of a sliding piece in FIG. 2.

### DETAILED DESCRIPTION

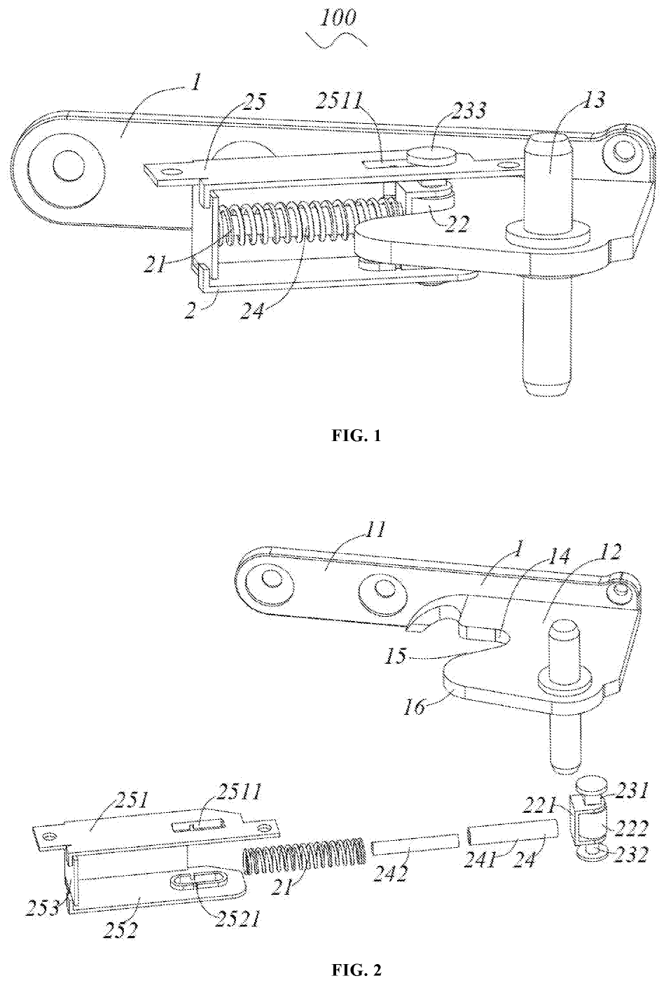

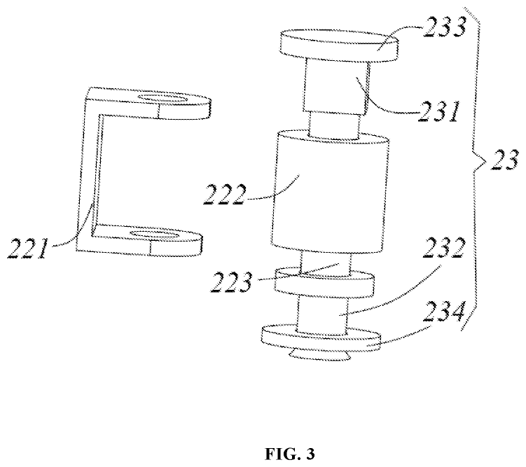

The present invention will be described in detail in conjunction with embodiments shown in figures. FIG. 1 through FIG. 3 show preferred embodiments of the present invention.

Referring to FIG. 1 through FIG. 3, a door hinge device 100 according to the present invention is mounted on an apparatus having a door boy to implement automatic closing of the door.

The door hinge device 100 comprises a hinge base 1 and an auxiliary door-closing mechanism 2 installed on the door and cooperating with the hinge base 1. When the door is closed, the auxiliary door-closing mechanism 2 provides assistance, to achieve the automatic closing of the door.

Specifically, the hinge base 1 comprises a fixing portion 11 to be secured on a cabinet, and a hinge base body 12 connected to the fixing portion 11 to cooperate with the door. A plane where the hinge base body 12 lies is a horizontal plane. The hinge base body is provided with a hinge shaft 13 extending in a vertical direction. The door is rotatably connected to the hinge base 1 through the hinge shaft 13 so that the opening and closing of the door can be achieved by turning the door.

The auxiliary door-closing mechanism 2 cooperates with the hinge base body 12 to implement automatic closing of the door.

The auxiliary door-closing mechanism 2 comprises a shell 25 secured to the door, an elastic piece 21 connected to the shell 25 and extending in a horizontal direction, a sliding piece 22 disposed at one end of the elastic piece 21 adjacent to the hinge base 1, and a guiding piece 23 for guiding the sliding piece 22 to move in a deformation direction of the elastic piece 21 during the process of opening and closing the door; a peripheral edge of the hinge base body 12 is concavely provided with an accommodating part 14 for receiving the sliding piece 22 when door is in a closed state, and with a guiding bevel 15 extending obliquely forward from a front end of the accommodating part 14 toward close to the auxiliary door-closing mechanism 2. During the process of opening and closing the door, the sliding piece 22 abuts against the guiding bevel and moves along the guiding bevel 15 under the action of the elastic restoring force of the elastic piece 21.

In the present invention, the guiding bevel 15 for controlling the movement trajectory of the sliding piece 22 is provided on the peripheral edge of the hinge base body 12, and it is unnecessary to additionally provide a guide structure, e.g., a cam member, for controlling the movement trajectory of the sliding piece 22, thereby increasing the force arm of the elastic piece 21 when the door is automatically closed, and enhancing the effect of automatically closing the door; meanwhile, the structure of the door hinge device 100 is simplified, and the cost is reduced.

The above-mentioned horizontal direction is not limited to a standard horizontal direction, that is, there may be a small angle between the extending direction of the elastic piece 21 and the horizontal direction.

One end of the elastic piece 21 away from the hinge base 1 is connected to the shell 25, that is, one end of the elastic piece 21 is connected to the shell 25 and the other end is connected to the sliding piece 22. The above connection may be a connection form such as a direct connection, an indirect connection, a fixed connection, or an abutment connection.

Specifically, in the present embodiment, the elastic piece 21 is a spring. Certainly, the elastic piece 21 may be other members with elasticity.

The sliding piece 22 comprises a fixing base 221 abutting against the elastic piece 21, a roller 222, and a rotating shaft 223 that rotatably connects the roller 222 to the fixing base 221. The rotating shaft 223 extends in the vertical direction; in the process of opening and closing the door, the roller 222 rolls along the guiding bevel 15 to reduce the friction between the sliding piece 22 and the guiding bevel 15 and better facilitate the movement of the sliding piece 22 along the guiding bevel 15.

During opening of the door, the sliding piece 22 comes out of the accommodating part 14 and moves in a direction away from the accommodating part 14 along the guiding bevel 15. During the movement of the sliding piece 22 away from the accommodating part 14 along the guiding bevel 15, the sliding piece 22 moves toward an end of the elastic piece 21 away from the sliding piece 22 under the guidance of the guiding piece 23 to make the elastic piece 21 is in a compressed state. At this time, under the action of the elastic restoring force of the elastic piece 21, the sliding piece 22 always abuts against the guiding bevel 15 so that the sliding piece 22 can roll along the guiding bevel 15.

At the same time, when the user opens the door and drives the sliding piece 22 to move to an end which is of the guiding bevel 15 and away from the accommodating part 14 and continues to open the door, the sliding piece 22 disengages from the hinge base 1 so that the door can freely rotate around the hinge shaft 13 so that the door can be opened to a large opening angle. After the sliding piece 22 disengages from the hinge base 1, the elastic piece 21 is switched from the compressed state to a free state under the action of the elastic restoring force and drives the sliding piece 22 to move synchronously.

During closing of the door, when the door drives the sliding piece 22 to move to the end which is of the guiding bevel 15 and away from the accommodating part 14, the elastic piece 21 is in the compressed state. Under the action of the elastic restoring force of the elastic piece 21, the sliding piece 22 abuts against the guiding bevel 15 and moves along the guiding bevel 15 towards the accommodating part 14 to thereby provide the user with assistance in closing the door, to drive the door to close automatically. After the elastic piece 21 drives the sliding piece 22 to move into the accommodating part 14, the door is in a closed state so that the function of automatically closing the door is achieved. This arrangement is simple in structure, easy to operate and not prone to damages.

Furthermore, the peripheral edge of the hinge base body 12 is further provided with a front guide surface 16 located at a front end of the hinge base 1 and connected to an end of the guiding bevel 15 away from the accommodating part 14. During closing of the door, the sliding piece 22 first contacts the front guide surface 16. During the movement of the sliding piece 22 along the front guide surface 16 toward the guiding bevel 15, the sliding piece 22 moves toward the end of the elastic piece 21 away from the sliding piece 22 under the guidance of the guiding piece 23, so that the elastic piece 21 is in the compressed state. At this time, under the action of the elastic restoring force of the elastic piece 21, the sliding piece 22 always abuts against the front guide surface 16 so that the sliding piece 22 can roll along the front guide surface 16 to the position where the guiding bevel 15 is located.

At the same time, during opening of the door, after the sliding piece 22 moves to the end of the guiding inclined surface 15 away from the accommodating part 14, the door continues to be opened, the sliding piece 22 switches from the guiding bevel 15 to the front guide surface 16. Under the action of the elastic restoring force of the elastic piece 21, the sliding piece 22 abuts against the front guide surface 16 and moves along the front guide surface 16 in a direction away from the guiding bevel 15 to open the door, thereby providing assistance to the user and facilitating the user to open the door.

Furthermore, the shell 25 comprises a first wall 251 fixed to the door, a second wall 252 disposed opposite to the first wall 251, a connecting wall 253 located at a side away from the hinge base 1 and configured to connect the first wall 251 with the second wall 252. It may be understood that the first wall 251 and the second wall 252 are respectively located on upper and lower sides of the horizontal plane where the hinge base body 12 lies.

An end of the elastic piece 21 away from the sliding piece 22 abuts against the connecting wall 253.

The guiding piece 23 comprises a first bump 231 disposed on a side of the sliding piece 22 towards the first wall 251. The first wall 251 is provided with a first sliding groove 2511 mating with the first bump 231 and extending in a deformation direction of the elastic piece 21. During the movement of the sliding piece 22 along the guiding bevel 15 and the front guide surface 16, the first bump 231 mates with the first sliding groove 2511, thereby guiding the sliding piece 22 to move in the deformation direction of the elastic piece 21 to cause the elastic piece 21 to deform.

Furthermore, the guiding piece 23 further comprises a second bump 232 disposed on a side of the sliding piece 22 towards the second wall 252. The second wall 252 is provided with a second sliding groove 2521 mating with the second bump 232 and extending in a deformation direction of the elastic piece 21. During the movement of the sliding piece 22 along the guiding bevel 15 and the front guide surface 16, the second bump 232 mates with the second sliding groove 2521, thereby guiding the sliding piece 22 to move in the deformation direction of the elastic piece 21 to cause the elastic piece to deform.

Specifically, the first bump 231 and the second bump 232 are disposed on opposite sides of the sliding piece 22, and the first sliding groove 2511 and the second sliding groove 2521 are disposed opposite to each other. In this way, during the movement of the sliding piece 22 along the guiding bevel 15 and the front guide surface 16, the mating between the first bump 231 and the first sliding groove 2511 in conjunction with the mating between the second bump 232 and the second sliding groove 2521 guides the sliding piece 22 to move in the deformation direction of the elastic piece 21 to cause the elastic piece to deform, and enhances the stability of movement of the sliding piece 22 in the deformation direction of the elastic piece 21.

Specifically, the first bump 231 and the second bump 232 are respectively disposed at two ends of the rotating shaft 223, and the first bump 231 and the second bump 232 are integrally formed with the rotating shaft 223.

Furthermore, the guiding piece 23 further comprises a first stopper 233 provided at an end of the first bump 231 and a second stopper 234 provided at an end of the second bump 232.

An outer diameter of the first stopper 233 in a width direction of the first sliding groove 2511 is larger than a width of the first sliding groove 2511, thereby preventing the first bump 231 from disengaging from the first sliding groove 2511, and enhancing the operating stability of the sliding piece 22.

An outer diameter of the second stopper 234 in a width direction of the second sliding groove 2521 is larger than a width of the second sliding groove 2521, thereby preventing the second bump 232 from disengaging from the second sliding groove 2521, and enhancing the operating stability of the sliding piece 22.

Furthermore, the auxiliary door-closing mechanism 2 further comprises a linear compression damper 24 configured to slow down a speed at which the elastic piece 21 switches from the compressed state to the free state under the action of the elastic restoring force during the door-closing process, so that the door automatically closes slowly, the door is presented from colliding with the cabinet upon quick closing of the door, and the door-closing noise is reduced.

One end of the linear compression damper 24 is connected to the sliding piece 22, and the other end is connected to the shell 25. AN axial extension direction of the linear compression damper 24 is the same as the deformation direction of the elastic piece 21, so that while the elastic piece 21 causes the door to close automatically, a damping force is provided to the elastic piece 21, the door is presented from colliding with the cabinet upon quick closing of the door, and the door-closing noise is reduced.

Specifically, one end of two ends of the linear compression damper 24 is connected to the connection wall 253, and the other end is connected to the fixing base 221.

The linear compression damper 24 comprises a casing 241 and a piston rod 242 at least partially inserted into the casing 241. The piston rod 242 can move in the axial direction of the linear compression damper 24 to change a length of linear compression damper 24 so that the length of the linear damper 24 is consistent with the length of the elastic piece 21 during opening and closing of the door.

It may be appreciated that when an end of the piston rod 242 away from the casing 241 is connected to the connecting wall 253, an end of the casing 241 away from the piston rod 242 is connected to the fixing base 221; when the end of the piston rod 242 away from the casing 241 is connected to the fixing base 221, the end of the casing 241 away from the piston rod 242 is connected to the connecting wall 253.

The spring 21 is sleeved around the linear compression damper 24. At the same time, one end of the spring 21 abuts against the fixing base 221, and the other end abuts against the connecting wall 253. During the movement of the sliding piece 22 along the guiding bevel 15 and the front guide surface 16, the spring can be prevented from bending, and the sliding piece 22 can be enabled to move in the deformation direction of the spring.

During opening of the door, the sliding piece 22 moves along the guiding bevel 15 in a direction away from the accommodating part 14, and the sliding piece 22 moves towards the connecting wall 253 to reduce the distance between the connecting wall 253 and the fixing base 221. At this time, the piston rod 242 retracts into the casing 241 to reduce the length of the linear compression damper 24, and meanwhile the spring is in the compressed state.

During closing of the door, the sliding piece 22 abuts against the guiding bevel 15 under the elastic restoring force of the spring. During movement along the guiding bevel 15 towards the accommodating part 14, the sliding piece 22 moves away from the connecting wall 253 to increase the distance between the connecting wall 253 and the fixing base 221, thereby driving the door to close automatically. Meanwhile, the piston rod 242, driven by the sliding piece 22, moves away from the casing 241 to provide a damping force to the spring, and slow down the speed at which the spring switches from the compressed state to the free state under the action of the elastic restoring force, so that the door closes slowly, the door is presented from colliding with the cabinet upon quick closing of the door, and the door-closing noise is reduced.

Furthermore, the present invention further provides a refrigerator having the above-mentioned door hinge device 100. The refrigerator comprises a cabinet, a door, and the above-mentioned door hinge device 100. The hinge base 1 is mounted on the cabinet, and the auxiliary door-closing mechanism 2 is mounted on the door.

Furthermore, the door is concavely provided with a receiving cavity for receiving the auxiliary door-closing mechanism 2. After the auxiliary door-closing mechanism 2 is mounted on the door, the auxiliary door-closing mechanism 2 is received in the receiving cavity, which enhances the overall visual effect of the door.

In summary, in the door hinge device 100 of the present invention, the peripheral edge of the hinge base 1 is provided with the guiding bevel 15 cooperating with the auxiliary door-closing mechanism 2, and sliding piece 22 is driven by the elastic restoring force of the elastic piece 21 to move along the guiding bevel 15 towards the accommodating part 14, thereby providing assistance to the user upon closing the door, achieving automatic closing of the door, meanwhile simplifying the structure of the auxiliary door-closing mechanism 2 and providing durability.

It should be understood that although the present specification is described based on embodiments, not every embodiment contains only one independent technical solution. Such a narration way of the present specification is only for the sake of clarity. Those skilled in the art should take the present specification as an entirety. The technical solutions in the respective embodiments may be combined properly to form other embodiments which may be understood by those skilled in the art.

So far, a person skilled in the art shall know that although a plurality of exemplary embodiments of the present invention have been described above in detail, various variations and improvements can be directly determined or deducted from the content disclosed by the present invention without departing from the spirit and scope of the present invention. Therefore, all those variations and improvements shall be deemed to be covered by the scope of the present invention.

1. A door hinge device, comprising a hinge base to which a door is rotatably connected, wherein the door hinge device further comprises an auxiliary door-closing mechanism, the auxiliary door-closing mechanism comprises a shell secured to the door, an elastic member bringing the door to close automatically during closing of the door, a sliding member disposed at one end of the elastic member adjacent to the hinge base, and a guiding member for guiding the sliding member to move in a deformation direction of the elastic member during opening and closing the door; an end of the elastic member away from the hinge base is connected to the shell, a peripheral edge of the hinge base is concavely provided with an accommodating part for receiving the sliding member when door is in a closed state, and with a guiding bevel extending obliquely forward from a front end of the accommodating part toward close to the auxiliary door-closing mechanism; the elastic member is in a compressed state when the sliding member moves along the guiding bevel, the auxiliary door-closing mechanism further comprises a linear compression damper, one end of the linear compression damper is connected to the sliding member, the other end is connected to the shell, and an axial extension direction of the linear compression damper is the same as the deformation direction of the elastic member.

2. (canceled)

3. The door hinge device according to claim 1, wherein the linear compression damper comprises a casing and a piston rod at least partially inserted into the casing, and the piston rod can move in the axial direction of the linear compression damper to change a length of linear compression damper.

4. The door hinge device according to claim 1, wherein the elastic member is a spring, and the spring is sleeved around the linear compression damper.

5. The door hinge device according to claim 1, wherein the sliding member comprises a fixing base abutting against the elastic member, a roller, and a rotating shaft that rotatably connects the roller to the fixing base; the roller rolls along the guiding bevel during opening and closing the door.

6. The door hinge device according to claim 1, wherein the shell comprises a first wall fixed to the door, the guiding member comprises a first bump disposed on a side of the sliding member towards the first wall, and the first wall is provided with a first sliding groove mating with the first bump and extending in a deformation direction of the elastic member.

7. The door hinge device according to claim 6, wherein the shell further comprises a second wall disposed opposite to and spaced apart from the first wall, the guiding member further comprises a second bump disposed on a side of the sliding member towards the second wall, and the second wall is provided with a second sliding groove mating with the second bump and extending in the deformation direction of the elastic member.

8. The door hinge device according to claim 7, wherein the shell further comprises a connecting wall located at a side away from the hinge base and configured to connect the first wall with the second wall, and an end of the elastic member away from the sliding member abuts against the connecting wall.

9. A refrigerator, wherein the refrigerator comprises a cabinet, a door, and a door hinge device; the door hinge device comprises a hinge base to which the door is rotatably connected, wherein the door hinge device further comprises an auxiliary door-closing mechanism, the auxiliary door-closing mechanism comprises a shell secured to the door, an elastic member bringing the door to close automatically during closing of the door, a sliding member disposed at one end of the elastic member adjacent to the hinge base, and a guiding member for guiding the sliding member to move in a deformation direction of the elastic member during opening and closing the door; an end of the elastic member away from the hinge base is connected to the shell, a peripheral edge of the hinge base is concavely provided with an accommodating part for receiving the sliding member when door is in a closed state, and with a guiding bevel extending obliquely forward from a front end of the accommodating part toward close to the auxiliary door-closing mechanism; the elastic member is in a compressed state when the sliding member moves along the guiding bevel, the hinge base is mounted on the cabinet, and the auxiliary door-closing mechanism is mounted on the door.

10. The refrigerator according to claim 9, wherein the door is concavely provided with a receiving cavity for receiving the auxiliary door-closing mechanism.

11. The door hinge device according to claim 5, wherein during opening of the door, the sliding member comes out of the accommodating part and moves in a direction away from the accommodating part along the guiding bevel.

12. The door hinge device according to claim 11, wherein during the movement of the sliding member away from the accommodating part along the guiding bevel, the sliding member moves toward an end of the elastic member away from the sliding member under the guidance of the guiding member to make the elastic member is in a compressed state, under the action of the elastic restoring force of the elastic member, the sliding member always abuts against the guiding bevel to make the sliding member roll along the guiding bevel.

13. A door hinge device, comprising a hinge base to which a door is rotatably connected, wherein the door hinge device further comprises an auxiliary door-closing mechanism, the auxiliary door-closing mechanism comprises a shell secured to the door, an elastic member bringing the door to close automatically during closing of the door, a sliding member disposed at one end of the elastic member adjacent to the hinge base, and a guiding member for guiding the sliding member to move in a deformation direction of the elastic member during opening and closing the door; an end of the elastic member away from the hinge base is connected to the shell, a peripheral edge of the hinge base is concavely provided with an accommodating part for receiving the sliding member when door is in a closed state, and with a guiding bevel extending obliquely forward from a front end of the accommodating part toward close to the auxiliary door-closing mechanism; the elastic member is in a compressed state when the sliding member moves along the guiding bevel, the sliding member comprises a fixing base abutting against the elastic member, a roller, and a rotating shaft that rotatably connects the roller to the fixing base; the roller rolls along the guiding bevel during opening and closing the door.
